(19) United States
(12) Patent Application Publication
(10) Pub. No.: US 2016/0339649 A1
(43) Pub. Date: Nov. 24, 2016

(54) SYSTEM AND METHOD FOR MONITORING AND CONTROLLING PRODUCTION OF COMPOSITE MATERIALS

(71) Applicant: Rock Creek Research, Norman, OK (US)

(72) Inventors: Thomas J. Rose, Norman, OK (US); Johann D. Rose, Norman, OK (US)

(21) Appl. No.: 15/225,416

(22) Filed: Aug. 1, 2016

Related U.S. Application Data
(63) Continuation-in-part of application No. 13/603,138, filed on Sep. 4, 2012.
Application No. 13/603,138 is a continuation of application No. 11/732,270, filed on Apr. 3, 2007, now abandoned.
Application No. 11/732,270 is a continuation-in-part of application No. 10/864,161, filed on Jun. 9, 2004, now abandoned.
(60) Provisional application No. 60/477,408, filed on Jun. 10, 2003.

(51) Int. Cl. B29C 70/54; G01N 25/20; G01N 21/65; B29C 35/02; G01N 11/00

(52) U.S. Cl. CPC B29C 70/54; B29C 35/0288; G01N 11/00; G01N 21/65; G01N 25/20; B29K 2101/12

(57) ABSTRACT

A method and system for analyzing and controlling the curing of a composite material part using information derived from composite material test samples obtained using an ex-situ analytical device.

### CROSS REFERENCE TO RELATED APPLICATIONS AND INCORPORATION BY REFERENCE STATEMENT

This is a continuation-in-part of U.S. Ser. No. 13/603,138, filed Sep. 4, 2012, which is a continuation of U.S. Ser. No. 11/732,270, filed Apr. 3, 2007, now abandoned, which was a continuation-in-part of U.S. Ser. No. 10/864,161, filed Jun. 9, 2004, now abandoned, which claims the benefit under 35 U.S.C. 119(e) of U.S. Provisional Application Ser. No. 60/477,408, filed Jun. 10, 2003, the entirety of which are each hereby expressly incorporated herein by reference.

### BACKGROUND OF THE PRESENTLY DISCLOSED INVENTIVE CONCEPTS

1. Field of the Presently Disclosed and/or Claimed Inventive Concepts

The presently disclosed inventive concept(s) relates generally to evaluation of material state properties of composite material parts during processing and more particularly but not by way of limitation, to a method and apparatus for implementing management and control of advanced composites based on analytically determined material state properties.

2. Brief Description of Related Art

Applications for composites range from fiber-filled cement in bridge structures to airplane wing spars but each requires a specific shape, strength, and stiffness. The production of various composites has the common elements of interspersing a binding material among fibers, shaping the product and causing the binder (also referred to herein as matrix) to change state in a manner to produce an acceptable structural product. Because it is the matrix, rather than the fibers, which changes state during production, management of the material state of the matrix throughout this process is critical. Also, during the storage of the materials, it is typically desirable to minimize changes in the material state. During forming and solidifying of the composite, it is desirable to manage the changes to material state to ensure the product achieves the desire state to ensure adequate post-production performance.

The generally accepted practice (conventional methodology) for controlling the material state during storage or processing of composite materials is to control the time and the temperature history of the part. These time and temperature shelf life requirement and production cure cycles were derived from analytical measurements of material state off line in a laboratory setting. These data are then used to develop process specifications that are presumed to achieve the appropriate state transitions. It has been the industry practice to accept a time and temperature cycle derived in this manner. This approach has been historically adequate to build certain structures, but is costly to develop, costly to implement and yields results that are far from optimal.

The historical industry practice requires a great deal of time, and a high skill level to generate the laboratory data which are needed to define the range of time and temperatures which are acceptable for storage and processing. This practice is expensive and ultimately loses the desirable level of control as the specifications are transferred to other activities, organizations change and time passes.

Under ideal conditions, the data generated in the laboratory are still not representative of the production environment. Thus, even the original manufacturing process lacks accuracy when comparing the desired versus actual material state. As the composite product moves from manufacturing to service and finally to maintenance and repair, the relation of the time and temperature specification to the actual material properties becomes even more tenuous. There have been many efforts to in the industry to make more direct measurements of the material state of the curable part during the actual production process and repair. A common approach has been to use sensors placed in-situ (i.e., in or on the part) and to attempt a feedback control. Many patent applications have been filed based on these systems however there has been no significant change to the methods actually used by industry.

While the in-situ sensors which have been investigated do register a change in some value during some part of the process, multiple interpretations can be, and have been given regarding the meaning of these changes. Often the changes are described as monitoring “cure”. Cure itself is then often described as being what the sensor measures. Unfortunately, the correlations suggested between in-situ measurements and the cure state as defined by the performance requirements of the part are often simple speculation. Further, some of these speculations have been accepted by some and have led to incorrect and potentially dangerous interpretations of cure.

For example, U.S. Published Patent Application 2001/0006264, filed by Wit et al., uses the inaccurate and dangerous assumption that equates a dielectric measurement to cure. In paragraph [0017] of that published application is the statement “The termination of the cure can be precisely determined when the ionic viscosity reaches its minimum, thereby signifying that the reactions of the composite materials have ended and no further crosslinking will take place”. This statement is simply not accurate. When the measurements obtained from dielectric sensors are compared directly to measures of viscosity obtained mechanically a very different picture occurs. Dielectric analyzer (DEA) measurements cease to follow the viscosity measurements at precisely the time that the final, critical stages of cure are just beginning.

This behavior is consistent with an article by S. D. Senturia and N. F. Sheppard, Jr. (discussed in more detail below in paragraphs 146-148) and other scientific findings. While in-situ dielectric sensors may have some utility, the failure to recognize their limitations could be catastrophic if the data derived from them are taken as the final measure of cure.

Another problem with the use of the “ionic viscosity” property cited by Wit et al. is the lack of an international standard or even a rigorous definition by which to determine when cure has taken place.

In the example of Wit et al., a sample (referee) is processed to determine a sensor response from zero to one hundred percent. The referee sample and the second device (a laboratory autoclave) must perform an identical process on identical material under identical conditions as the production autoclave to establish equivalence of the data. Thus all conditions of the production autoclave must be reproduced in the laboratory autoclave to give meaning to the laboratory data. Any differences in material or process from the referee sample used to determine percent of cure and the sample in the production or the sample in the laboratory autoclave would violate the basis upon which the measurement of percent of cure is based. Any change in the part or its location within the autoclave (even if the autoclave temperature is identical) or in part thickness will change the heat transfer into the part, and therefore create a difference in part temperature and cure rate.

The Wit et al. reference, therefore, cannot allow changes in the remote device (test autoclave) in any way that would make it less than fully representative of the production device in all respects.

Among the most critical material state properties requiring management are the viscosity and stiffness of the matrix. The matrix must be in a fluid state to infuse the reinforcing material, and sufficiently soft for permitting the composite material part to be formed into the desired shape and finally to achieve the appropriate viscoelastic state for the particular use of the product. Other important matrix properties of the part include its composition, cure state, cross-link density, reactive volatiles, absorbed moisture, and presence of other non-reactive volatiles. Other use-specific properties, including but not limited to, conductivity or color may also be critical to product performance.

The current methods for producing composite structures typically rely on the management of the local process or storage environment around the material for each stage of the production and storage process based on prior analysis of the materials. The material state of the matrix is assumed to change in accordance with the original materials analysis.

A review of the prior art reveals numerous material state sensors and cure models proposed to monitor cure state and act as feedback for control and material management.

In-Situ Sensors

As mentioned above, U.S. Published Patent Application 2001/0006264, filed by Wit et al., exemplifies the complexity, difficulty and inaccuracy associated with the use of in-situ sensors (in particular dielectric sensors) for defining cure. Wit et al. attempted to overcome the complexity and difficulty issues for the production shop by using a test autoclave to remotely duplicate production conditions in the laboratory or similar location. This step would be unnecessary if the in-situ sensors placed on the primary curable part were reliable or easily implemented in a production setting (thereby bringing into question their value or purposefulness). Wit et al. attempted to provide meaning to the remote in-situ dielectric sensor signals by proposing that they represent a viscosity measurement. But the term “ionic viscosity” used by Wit et al. is not an actual viscosity measurement and therefore cannot be compared to an actual viscosity standard, and thus cannot be used accurately in an application where measurements of actual viscosity are critically important. The method used by Wit et al., also has no significant response to the elastic modulus of the part which is critical to structural strength and therefore which is critical to the definition of cure for a structural part. The limitations of dielectric measurements are that the correlation to mechanical properties, where it exists at all, only exists in a limited range during the cure and is subject to many sources of systematic error (such as discussed in the following Zsolnay patents).

U.S. Pat. Nos. 4,399,100 and 4,373,092 issued to Zsolnay describe an in-situ dielectric sensor. These sensors and similar sensors based on the electrical conductive have been extensively evaluated and occasionally used during cure monitoring. The disadvantage is the added cost of installing the sensors and the limited value of the data generated. Shorts caused by conductive fibers and incomplete wetting of the sensor can lead to gaps in the data and erratic responses. Even when the sensor response is ideal, and if viscosity did correlate reliably for a selected material, there would need to be a secondary calibration and conversion of electrical properties to viscosity to provide data meaningful to the process.

U.S. Pat. Nos. 4,455,268, 4,515,545 and 4,559,810 issued to Hinrichs describe the use of in-situ ultrasonic sensors. These and similar sensors using sound attenuation, sound velocity and sound frequency response also exhibit problems with sensor installation, wetting by the matrix and secondary conversion of data to obtain meaningful viscoelastic material state properties. Sensor size and placement are also problematic.

U.S. Pat. No. RE33789 issued to Stevenson describes process monitors using in-situ spectroscopic monitoring. These methods require complex tooling and setup to obtain results. The placement of these sensing systems within an autoclave or other processing environment typical of composite processing is a major task and requires a high degree of technical oversight. The utility of these sensors is limited to materials that have spectral responses that would permit monitoring of absorption peaks critical to material performance.

U.S. Pat. No. 5,262,644 issued to Maguire describes a method of monitoring cure using Raman spectroscopy with imbedded, in-situ fiber optic sensors. This method requires laser light to be transmitted through fibers to and from a Raman spectrometer placed outside of the cure chamber. Imbedding the fibers in the composite material part and making low loss optical connections create added complexity. Handling the fibers to ensure breakage does not occur is also a problem. The resultant data is a Raman spectrum which only has utility for materials that have spectral peaks relevant to material performance. Data interpretation is complex and requires skill in chemistry.

U.S. Pat. No. 5,321,358 describes a method and apparatus for monitoring and control using NMR. This method requires extensive preparation and induction of magnetic fields into the composite material part. The complexity of this method eliminates it from general utility for composite production.

For the reasons stated, none of these methods involving prior art sensors has developed substantial use for production control because of difficulties in application and interpretation. Each of these methods requires additional sensors to be inserted within or substantially adjacent to the composite material part being processed. The process equipment and tooling present a difficult and often hostile environment for in-situ sensors and accurate measurement is not possible for many of the properties that are critical to product quality and process control. Efforts to overcome the inadequacies of the sensor data using mathematical means further adds to the complexity of the process. Even when the in-situ sensor can readily withstand the process conditions, there are issues of sensor placement, and the challenges of bringing the sensor leads from the tooling through the walls of processing equipment and to the device for converting the sensor signal to meaningful data. Another problem with conventional in-situ sensors is that verification of the estimated material properties must be done as a separate operation using laboratory staff. This adds greatly to the cost and time required to observe meaningful data.

Feedback Control

Because of the added cost, limited robustness, and difficulty in using the in-situ sensors, their application in process control has been limited almost exclusively to research or specialized applications. The need for separate laboratory studies to correlate and correct the in-situ sensor data further inhibits their utility as control feedback in a real time control loop. Another problem with conventional in-situ material sensors is gaps in the data caused by insufficient wetting of the sensor or other causes. This further adds to the difficulty of implementing effective feedback by requiring additional process rules and software development.

Models to Estimate Material State for Process Evaluation and Control

U.S. Pat. No. 4,773,021 issued to Harris et al. describe an adaptive model-based schedule for applying pressure to a press based on calculated percent of cross-link completed and associates a drop in material conductivity with the model. The in-situ conductivity sensor cited by Harris retains the difficulties of added level of effort to insert, difficulties in wetting, shorts, and unreliable data as noted regarding in-situ sensors and does not provide any direct measurement readily associated with the mechanical state of the material.

U.S. Pat. No. 4,810,438 issued to Webster et al. describe a method for computing gel time from time and temperature and taking control actions based on the computed percent of gel. The calculation of gel time proposed by Webster lacks any means of validation during the cure process itself and presumes an existing cure state at the beginning of the process that may be highly inaccurate.

U.S. Pat. Nos. 5,207,956 and 5,453,226 issued to Kline and Altan describe methods of controlling cure processes by comparing measurements of real parameters of composite parts to predicted values of the parameters and adjusting a curing process based on the comparison. This approach suffers from the same issues of the prior art for both in situ sensors and model predications since the corrections are proposed to be based on values that are themselves of questionable accuracy with regard to the critical material state properties and both the model development and the sensor placement add to cost without providing significant improvement versus current practice.

While the devices in the prior patents may be suitable for certain specialized applications they do not provide a means to significantly reduce costs or improve the quality of the process or product.

In view of the foregoing disadvantages inherent in the known methods for managing the production of composite material parts, new methods and apparatus as described below have been developed that overcome the difficulties inherent in the equipment and methods heretofore known.

### BRIEF SUMMARY

The inventive concept(s) disclosed and claimed herein relates generally to a method of curing a composite material part including the following steps. A curable part(s) comprising a resin and fiber composite material is disposed within a process environment. A test sample constructed of a same resin and fiber composite material as that used to construct the curable part(s) is disposed in analytical equipment comprising a rheometer which is separate from the process environment. Multiple temperature measurements of air within the process environment are obtained while the curable part is being subjected to selected curing conditions of a cure cycle. Multiple temperature measurements substantially adjacent the curable part(s) at multiple locations of the curable part(s) within the process environment are also obtained while the curable part is being subjected to the selected curing conditions. A representative part temperature is determined based on the multiple temperature measurements substantially adjacent the curable part(s). A setting of the analytical equipment is adjusted so as to control the temperature of the test sample to equal the determined representative part temperature and real time measurements of the test sample including viscoelastic properties of the test sample are obtained at the determined representative part temperature and under conditions within operating specifications of the instrument. Air temperature within the process environment is controlled using a process management system having a computer program with instructions for computing an air temperature set point and adjusting that set point based, in part, on the real time viscoelastic property measurements of the test sample. A cure state of the curable part(s) is estimated based on the real time measurements of the test sample and the multiple temperature measurements substantially adjacent the curable part(s) at multiple locations of the curable part(s).

### BRIEF DESCRIPTION OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a graph showing the use of differential scanning calorimetry (DSC) during a cure cycle.

FIG. 2 is a graph showing shear modulus vs. time and temperature in a cure process.

FIG. 3 is a schematic diagram of the presently disclosed inventive concept(s) showing data flow and major components.

FIG. 4 is a graph showing temperature and modulus information taken during a cure cycle.

FIG. 5 is a graph showing temperature and modulus information of another composite material taken during a cure cycle.

FIG. 6 is a graph showing temperature and modulus of another composite material taken during a cure cycle.

FIG. 7 is a graph showing temperature and modulus of another composite material taken during a cure cycle.

FIG. 8 is a graph showing several multi-location thermocouple measurements taken of a composite material during a cure cycle.

### DETAILED DESCRIPTION OF EXEMPLARY EMBODIMENTS

Before explaining at least one embodiment of the presently disclosed inventive concept(s) in detail, it is to be understood that the presently disclosed inventive concept(s) is not limited in its application to the details of construction and the arrangement of the components or steps or methodologies set forth in the following description or illustrated in the drawings. The presently disclosed inventive concept(s) is capable of other embodiments or of being practiced or carried out in various ways. Also, it is to be understood that the phraseology and terminology employed herein is for the purpose of description and should not be regarded as limiting.

Unless otherwise defined herein, technical terms used in connection with the presently disclosed inventive concept(s) shall have the meanings that are commonly understood by those of ordinary skill in the art. Further, unless otherwise required by context, singular terms shall include pluralities and plural terms shall include the singular.

All of the articles and/or methods disclosed herein can be made and executed without undue experimentation in light of the present disclosure. While the articles and methods of the presently disclosed inventive concept(s) have been described in terms of preferred embodiments, it will be apparent to those of skill in the art that variations may be applied to the articles and/or methods and in the steps or in the sequence of steps of the method described herein without departing from the concept, spirit, and scope of the presently disclosed inventive concept(s). All such similar substitutes and modifications apparent to those skilled in the art are deemed to be within the spirit, scope, and concept of the presently disclosed inventive concept(s).

As utilized in accordance with the present disclosure, the following terms, unless otherwise indicated, shall be understood to have the following meanings:

The use of the word “a” or “an” when used in conjunction with the term “comprising” in the claims and/or the specification may mean “one”, but it is also consistent with the meaning of “one or more,” “at least one,” and “one or more than one.” The use of the term “or” in the claims is used to mean “and/or” unless explicitly indicated to refer to alternatives only or that the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects. For example, but not by way of limitation, when the term “about” is utilized, the designated value may vary by plus or minus twelve percent, or eleven percent, or ten percent, or nine percent, or eight percent, or seven percent, or six percent, or five percent, or four percent, or three percent, or two percent, or one percent. The use of the term “at least one of X, Y, and Z” will be understood to include X alone, Y alone, and Z alone, as well as any combination of X, Y, and Z. The use of ordinal number terminology (i.e., “first,” “second,” “third,” “fourth,” etc.) is solely for the purpose of differentiating between two or more items and is not meant to imply any sequence or order or importance to one item over another or any order of addition, for example.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination unless otherwise apparent from the context.

As used herein, the term “substantially” means that the subsequently described event or circumstance completely occurs or that the subsequently described event or circumstance occurs to a great extent or degree. For example, when associated with a particular event or circumstance, the term “substantially” means that the subsequently described event or circumstance occurs at least 80% of the time, or at least 85% of the time, or at least 90% of the time, or at least 95% of the time. The term “substantially adjacent” may mean that two items are 100% adjacent to one another, or that the two items are within close proximity to one another but not 100% adjacent to one another, or that a portion of one of the two items is not 100% adjacent to the other item but is within close proximity to the other item.

The term “associate” as used herein will be understood to refer to the direct or indirect connection of two or more items.

It has been a long-desired goal to be able to accurately model and to monitor the material state of the composite matrix in real time during production, storage, forming and hardening of a composite material part. There have been many previous attempts to achieve this objective using, as noted above, in-situ sensors to (1) monitor of the material state of the composite matrix, (2) provide feedback for process control, and (3) generate or validate models to estimate material state conditions.

The desire to monitor the material state is reflected, for example, in the number of patents generated to address these goals. However, none of these patents has resulted in general applications useful for the production of composite material parts. In particular these sensors have typically relied on definitions of cure based on a percentage of their range of response rather than measurement of a useful property such as whether the material is water like or tar like.

As explained above, a general problem with the current state of the art is that existing methods using in-situ sensors and cure models are costly to apply and difficult to implement and yield data which typically require a skilled interpretation and further are often of questionable accuracy, as are the models of cure. The lack of a means to rapidly generate and reliably validate models during production is an additional burden.

The inventive concepts disclosed and claimed herein relate generally to the need for a more reliable and cost effective method of curing composites given the failure of prior art efforts to achieve the level of confidence needed for critical structures. Embodiments of the inventive concept(s) described herein include separation of cure measurement and model validation from process control. This differs from prior art inventions which have been based on closed loop control with respect to the cure sensor. Implementation of the inventive concept(s) disclosed herein includes independent control of the processing equipment based on its heat transfer, and other features and a separate control for the test instruments which resides in an environment intended to provide optimal performance and accurate results. The introduction of a cure management interface between the cure control and the material cure state testing enriches the database from each and enables optimizing new set points to either the test instrument or the process control based on the data received from both. Because the data from the analytical device can be verified as accurate without interpretation or unknown effects of the in-situ environment and; because the process control can retain in its memory the limitations on process from either legacy or design, the confidence in the outcome is enhanced rather than diminished and process changes based on the test data are substantiated by the available data. This is contrary to prior art that seeks to establish closed loop control. The patent application of Wit illustrates the logical but flawed thinking of the prior art which, rather than improving confidence in structural integrity, adds the uncertainty. The prior art combines issues of model uncertainty with the special handling needed for in situ sensor, self-referencing cure models that change from batch to batch and with time, the differences in heat transfer of small samples and large parts in small and large autoclaves respectively and includes a closed feedback loop to the sensor or model for cure management that ensuring that any errors introduced by the cited issues will be reflected in the product. Wit's approach is similar to other inventions in the prior art. Specifically, cure models such as those proposed by Webster, Kline and Harris are not refereed at the point of manufacture and thus may be inaccurate for the specific batch and aging effects. In situ sensor such as Hinrichs, Stevenson, Maguire, Wit and Zsolnay are compromised by their need to function in hostile environments, requiring special handling to acquire data and special interpretation to correlate to a meaningful property. Since they are only calibrated relative to prior results, the accuracy of the data cannot be easily verified, and the data are useless if the material changes (which it will) from the time of calibration to the time of production.

Management of composite material part production using material state properties is enabled by the presently disclosed inventive concept(s) by conveying information about the process environment and the curable part therein to one or more analytical devices, then obtaining material state data ex-situ using the one or more analytical devices rather than in-situ sensors. Viscoelastic state, for example, is one of the most critical material state properties of the curable part and is given special attention in the presently disclosed inventive concept(s), but the scope of the inventive concept(s) is not limited to measurement of this property.

In the presently disclosed inventive concept(s), data are interpreted with reference to external calibration standards typical of certified analytical devices such as those maintained by internationally recognized standard bureaus such as NIST and ISO (in contrast to the system described by Wit et al., for example, that depends entirely on the duplication of the process environment and material processed by a test autoclave).

The approach used in the presently disclosed inventive concept(s) (i.e., using ex-situ measurements derived from analytical devices) is counterintuitive in that it is not fully representative of the production process.

The presently disclosed inventive concept(s) replaces and/or improves upon the function of prior art systems which rely on in-situ sensors by using ex-situ data collection via apparatus and method that incorporates analytical devices in a way that overcomes the limitations of the prior art and greatly enhances the utility of many of the analytic devices known to the industry. The presently disclosed inventive concept(s) achieves its objectives by obtaining material state information from test samples by using one or more pieces of analytical equipment (e.g., a rheometer) to approximate certain conditions of the process environment and then utilizing the information in a unique way to achieve a more reliable and optimized process.

In contrast to the in-situ measurements and unsubstantiated models of the prior art, the method and apparatus of the presently disclosed inventive concept(s) provides clear and unambiguous measurements. There is no requirement to redefine the meaning of cure or viscosity. Although the presently disclosed inventive concept(s) does not attempt to define what constitutes a final cure state (this is the prerogative of the end user of the material) it does provide the means by which to analyze the condition of the material in the same manner as the laboratory personnel who generated the specification defining cure. This is counter to approach of the prior art cited herein that must provide their own definitions of cure in order to show utility.

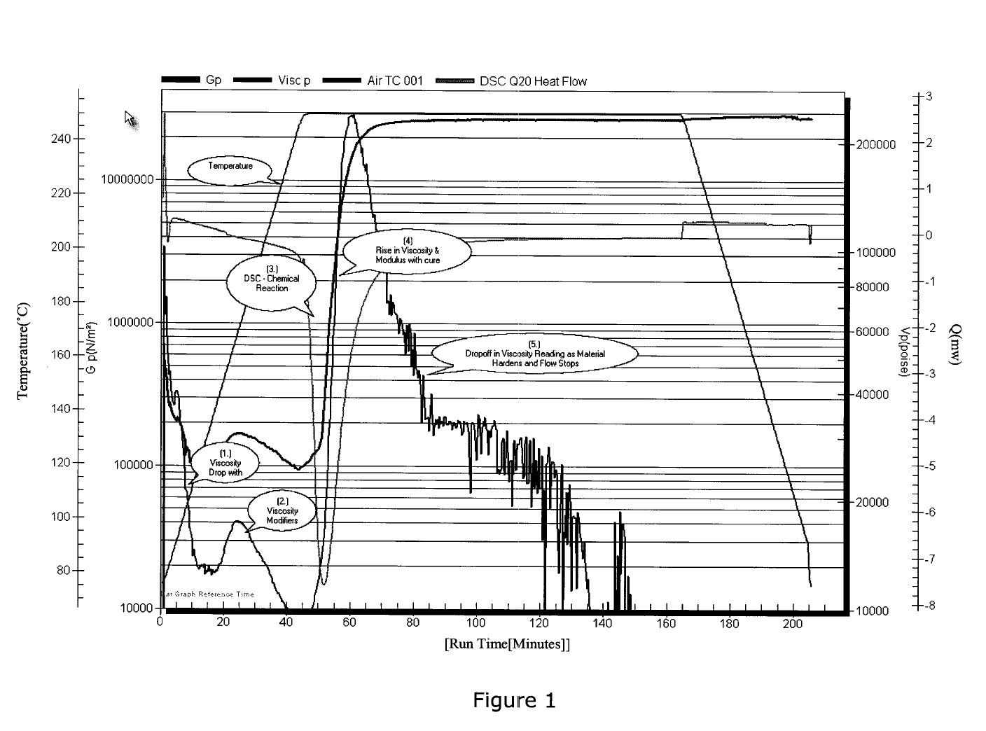

For example, as shown in the FIG. 1, the heat evolved from the chemical reaction is measured in watts and the mechanical properties in Pascals both of which can be referenced to international standards. As described below, these properties can then be used to determine the overall state of the material and to take appropriate actions involving degassing or consolidation, and to continue or end the process.

FIG. 1 shows an example of the real time measurements taken from a system of the presently disclosed inventive concept(s) wherein heat of reaction is monitored as an indication of the chemical reaction rate. All of this data is available in near real time for use in managing the primary production process. Clearly, quantitative data that can be related to real physical and chemical properties provide a far better basis for making processing decisions than sensors which report values of zero to one hundred as a percentage of the response of the sensor itself.

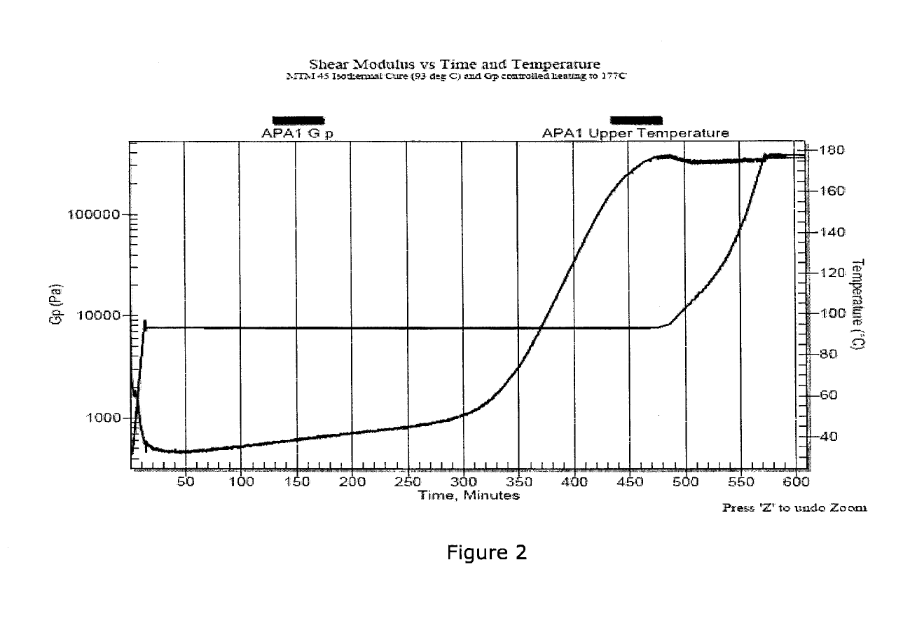

FIG. 2 illustrates measurements and controls not possible with in-situ sensors that define cure as a percentage of their range of measurement. A goal of the process shown in FIG. 2 is to cause the composite material to harden to an elastic solid as measured by a Dynamic Mechanical Analyzer (DMA) at a temperature of 93° C. to minimize residual stress in the part. The temperature of the component is then raised (using data stored or resident within the Process or Storage Management System 20 at a rate such that the resin does not re-soften but continues to cure (cross-link) and increase the glass transition temperature to a level accepted as full cure in many applications.

The so called “ionic viscosity” of Wit et al., for example, would stop changing where the elastic shear modulus (G′) begins its rapid increase. At this point in the cure the material is solid but not fully cured as would be implied based on the method of Wit. Thus an interpretation of cure that is based on cure as a percentage of the measurement range of the dielectric sensor would erroneously report the cure as complete. Further, an objective of the process (to monitor and manage a low temperature hardening of the resin followed by extended cross linking of the resin to increase its service temperature) would not be possible using the method of Wit.

The design, method, and apparatus of the presently disclosed inventive concept(s) for assessing and managing material properties make it possible to greatly improve on the conventional methods of time and temperature management. It was not previously recognized that the measurements taken in the manner presently described and claimed (which may be less accurate and reliable than data generated in tedious “off-line” characterizations) still retain greater accuracy and ease of interpretation than data obtained from many in-situ sensors. Further, although the accuracy may be compromised relative to “off line” laboratory-generated data, the information gained in the manner of this patent is likely to be far more representative of the production product than the data associated with specification development in the laboratory.

The teachings herein also provide a means to better utilize sensors that may be located in-situ in the primary composite material part undergoing cure. Since an accurate determination of material properties is possible using the present analytical devices, such data can be fed back to the Process or Storage Management System 20 to filter errors that may occur during data acquisition and to interpret the material properties associated with thermocouples or other in-situ sensors in the composite part.

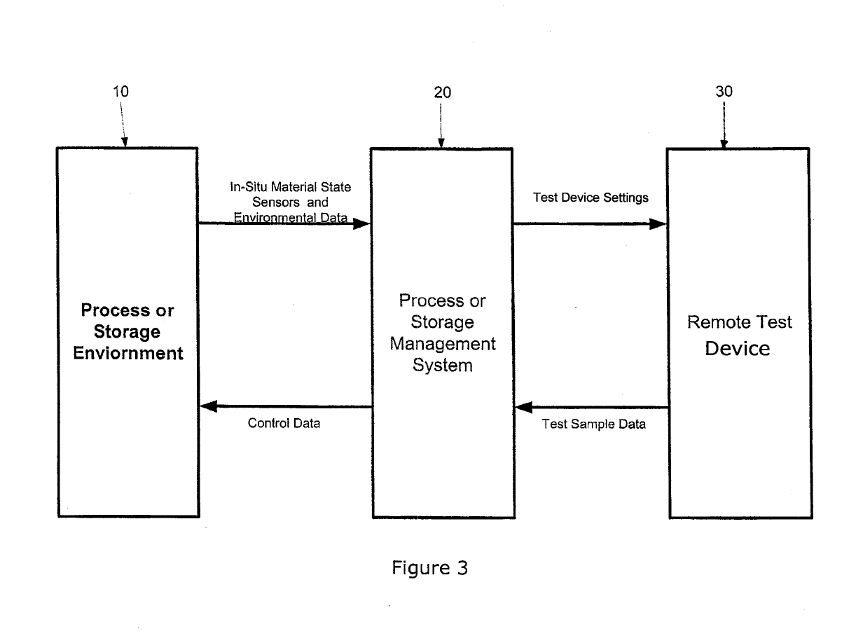

Turning now to FIG. 3, in one embodiment, a method of curing a composite material part includes the following steps. A curable part(s) comprising a resin and fiber composite material is disposed within a process (or storage) environment 10. A test sample constructed of a same resin and fiber composite material as that used to construct the curable part(s) is disposed in analytical equipment 30, sometimes referred to as “remote test device 30,” which is separate from the process environment 10. The analytical equipment 30 includes at least a rheometer. Multiple temperature measurements of air within the process environment are obtained while the curable part is being subjected to selected curing conditions of a cure cycle. Multiple temperature measurements substantially adjacent the curable part(s) at multiple locations of the curable part(s) within the process environment are also obtained while the curable part is being subjected to the selected curing conditions. The process or storage management system 20 determines a representative part temperature based on the multiple temperature measurements substantially adjacent the curable part(s). A setting of the analytical equipment 30 is adjusted so as to control the temperature of the test sample to equal the determined representative part temperature and real time measurements of the test sample including viscoelastic properties of the test sample are obtained at the determined representative part temperature and under conditions within operating specifications of the instrument. Air temperature within the process environment 10 is controlled using the process management system 20 having a computer program with instructions for computing an air temperature set point and adjusting that set point based, in part, on the real time viscoelastic property measurements of the test sample. A cure state of the curable part(s) is estimated based on the real time measurements of the test sample and the multiple temperature measurements substantially adjacent the curable part(s) at multiple locations of the curable part(s). In some embodiments, multiple cure states of the curable part(s) are estimated based on the real time measurements of the test sample and the multiple temperature measurements substantially adjacent the curable part(s) at multiple locations of the curable part(s).

The presently disclosed inventive concept(s), contrary to the prior art, does not rely on cure state sensors placed in-situ and does not exactly duplicate the process environment as is explained in detail below. The presently disclosed inventive concept(s) uses data generated in an analytical device that can be verified as accurate with reference to a NIST standard and without reference to a prior cure of the material itself as described by Wit. Data from the production unit in which the main part is being processed is used to determine the analytical device set point but without a requirement to duplicate any specific temperature within the production unit. The analytical device will, by definition, be calibrated to international standards and accurately measure the property for which it is designed. The temperature distribution among or within a production part is used to determine a set point to the analytical device but does not necessarily represent any specific temperature measurement of the part or parts.

The unexpected advantage of the method of the presently disclosed inventive concept(s) is that although aspects of the analytical data may be compromised, and the method is not fully representative of conditions in the process environment, it has far better accuracy than the current state of the art for cure management in the production environment and provides a better representation of the physico-chemical processes occurring in the curable part in the process environment.

Where an environmental property of the composite material part such as temperature or pressure can be readily estimated but cannot be directly measured (such as a critical temperature deep within the part), such estimates can be used to either drive the ex-situ analytical device, or used by the control computer to make temperature adjustments to the material model and to estimate material properties deep within the part.

In certain embodiments, such as wherein the composite material part comprises a thick laminate, multiple analytical devices and models may be used together to provide more accurate estimates for complex loads. For example, the analytical equipment may further include a calorimeter and method include obtaining real time measurements of the heat generation and absorption of the test sample and estimating heat generation and absorption of the curable part based on the heat generation and absorption measurements of the test sample. The heat content of an exothermic reaction in one test sample can be measured by differential scanning calorimetry (DSC) and this measurement can be used in conjunction with a rheometer to measure viscosity in a separate test sample. The caloric content measured by the DSC can provide a means to estimate the heat rise in a thick laminate, to monitor its effect on viscosity, and to manage the process to control both.

In one embodiment, the analytical equipment 30 includes a thermo-gravimetric analyzer. Real time measurements of the weight change of the test sample at the temperature approximating the curable part temperature can be used to estimate the weight change of the curable part.

In one embodiment, the analytical equipment 30 further comprises a Raman spectrometer. The Raman spectrometer is used to obtain real time measurements of the absorption or emission spectra of the test sample at the measured temperature substantially adjacent to the curable part. The absorption or emission spectra measurements can then be used to estimate a chemical composition or chemical change in the curable part during the curing of the curable part.

The method for curing a composite material part can include the step of terminating the curing conditions of the cure cycle when the cure state estimates of the curable part(s) and the temperature measurements substantially adjacent the curable part(s) indicate the curing process is complete. In one embodiment, additional rheological measurements of the test sample are made to estimate the glass transition temperature of the resin and fiber composite part once curing conditions are terminated.

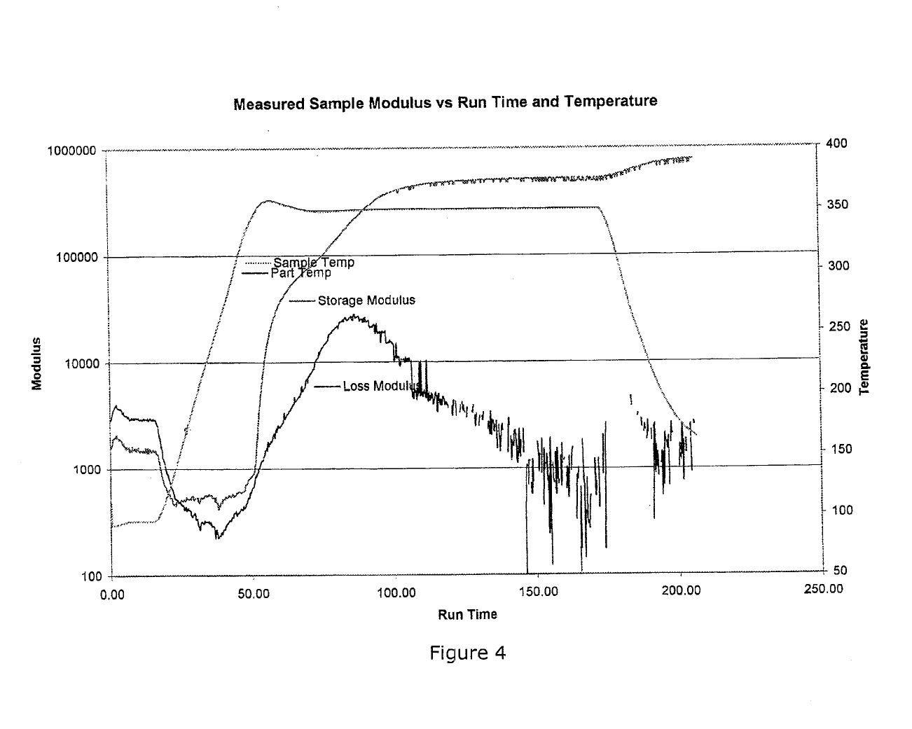

Some embodiments include the step of terminating the curing conditions of the cure cycle when the viscoelastic property measurements of the test sample over time show a loss modulus peak followed by a decline of the loss modulus to levels near zero where readings become erratic. The “near zero” level and erratic measurement is shown and demonstrated in FIG. 4 which is discussed in more detail in the Examples that follow. In one embodiment the “near zero” level for the loss modulus is defined as 1000 kPa or less.

The presently disclosed inventive concept(s) also provides a rapid and inexpensive method to calibrate in-situ sensors in the primary curable part and validate cure models. Another use for the presently disclosed inventive concept(s) is the rapid and inexpensive development of cure models by fitting the proper mathematical functions to the data from the analytical equipment as a part of the computer program.

The method and system for concurrent material testing according to the presently disclosed inventive concept(s) substantially depart from previously known concepts and designs. It greatly improves on the prior art by providing a robust, low-cost approach to obtaining material state properties of the composite material part during processing. It provides novel means for executing process management in the production, storage and conversion of composite material part from production of the matrix, infusion into the fibers, storage and cure.

For example, additional process control can include the step of adjusting at least one process environment condition prior to when the multiple cure state estimates indicate the curing process is complete. In one embodiment, the process environment temperature is adjusted to maintain a constant viscosity of the composite material as it cures. This maximizes infusion of the resin among the fibers.

In one embodiment, the curable part comprises a laminate and process environment conditions are controlled to cause the curable part viscosity to increase and restrict flow as pressure is applied. In this manner, pressure builds within the resin and helps to close voided areas.

In one embodiment, a selected temperature in the process environment is held constant until test sample measurements show that the loss modulus has passed its peak and diminished to a level indicating a fully elastic state is achieved. In this manner residual stress in the curable part is minimized.

In another embodiment, the step of adjusting at least one process environment condition comprises causing the resin viscosity to increase such that the resin is solid at room temperature but re-melts when placed within another part for more complex structures.

In yet another embodiment, the process environment is an autoclave. The autoclave curing conditions can be terminated before the cure cycle is complete when the real time measurements of the test sample indicate the glass transition temperature is high enough to allow the curable part to be removed from the autoclave and the cure cycle completed in a less expensive oven.

The general purpose of the presently disclosed inventive concept(s), which will be described below in more detail, is to provide a system and method for material state sensing which will enable the user to more effectively prepare specifications, assess the state and assure consistency of raw materials, monitor the real-time material state during storage and to manage the conditions of a composite material part during the curing process.

The system and method of the presently disclosed inventive concept(s) preferably comprises:
1) one or more analytical devices (test devices) which are sensitive to material state properties of test samples of a material and are capable of receiving and/or sending remote data;
2) storage or production devices (storage or process environments) in which the material's viscoelastic properties are managed, such as in a freezer, lay-up room, oven, autoclave, press or ambient cure station;
3) environmental sensors substantially adjacent to the composite material part or parts in the process or storage environment or designed to provide an acceptable estimate of conditions within or substantially adjacent to the composite material part;
4) a process or storage management system capable of obtaining and sending data from the environmental sensors and sending and receiving data to the analytical device(s);
5) means to adjust the settings of the analytical device(s) in accordance with the values of selected parameters obtained by the environmental sensors;
6) optionally, means to read the data received from the analytical device(s);
7) optionally, a data acquisition and computer control system to monitor or manage the material process or storage environment capable of sending and/or receiving remote data;
8) optionally, means to send data from the analytical device(s) to the process or storage management system;
9) optionally, means to adjust the environment controls of the process or storage environment based on data received; and
10) optionally, an internet or other wide area networking interface to make remotely located data or equipment functionally available at the production site.

The system of the presently disclosed inventive concept(s) has utility to assess the state of incoming materials prior to placing in storage, manage the storage conditions intended to minimize material state change and the process conditions intended to cause change in material state of the composite material part. Each aspect has utility for improved material state management, whether considered separately or in combination.

It is to be understood that the presently disclosed inventive concept(s) is not limited in its application to the details of construction or to the arrangements of the components set forth in the following description or illustrated in the drawings. The presently disclosed inventive concept(s) is capable of other embodiments and of being practiced and carried out in various ways. Also, it is to be understood that the phraseology and terminology employed herein are for the purpose of the description and should not be regarded as limiting. The presently disclosed inventive concept(s) may be embodied in the form illustrated in the accompanying drawings, attention being called to the fact, however, that the drawings are illustrative only, and that changes may be made in the specific construction illustrated in a manner known to those of ordinary skill in the art.

Turning again to the figures, shown in FIG. 3 and designated by the general reference numeral 10 is a process or storage environment which represents the storage area or process equipment surrounding the material or fixtures or containers that are in intimate contact with the primary material part to be used or cured. Examples include autoclaves, freezers, clean rooms or ovens as well as forming tools, fixtures, and dies. With respect to the presently disclosed inventive concept(s), ambient environmental conditions may be considered a storage device to the degree they promote or inhibit changes in material that its effects can be assessed and controlled by changing the location of the materials.

Designated by the general reference numeral 20 is a process or storage management system composed of a data storage device, a user interface, a processor and software. Examples include any commercially available or specially built process control systems that have been modified and/or designed to include with the functional capabilities described elsewhere herein.

Designated by the general reference numeral 30 is a remote test device which represents a commercially available analytical device or equipment or special equipment designed to provide accurate material state data relevant to processing or storage of the composite materials or other materials contemplated herein. Examples include, but are not limited to, a commercial rheometer, calorimeter or thermo-gravimetric analyzer, or Raman spectrometers, the purpose of which is primarily to provide accurate and reliable readings of material state data. Specific examples of each of these include, but are not limited to, the TA Instruments Q20, Alpha Technologies ATD CSS2000 rheometer, TA Instruments RDA III Rheometer, the TA Instruments Q600 simultaneous thermo-gravimetric and differential scanning calorimeter, and Kaiser Optics Raman RNX. In one embodiment, the analytical device used in the remote test device 30 is a TA instruments Q600 simultaneous thermo-gravimetric and differential scanning calorimeter which can simultaneously measure thermogravimetric and DSC properties. The pressure/vacuum that is seen by the part will affect the cure state and other material properties of condensation polyimides used as the matrix in high temperature applications. The various analytic devices described herein for use in the claimed method (such as rheometers, calorimeters, thermogravimetric analyzers, and IR absorption and emission analyzers) for measuring various parameters of the test samples are not constructed to tolerate process environments such as occur within production autoclaves during the cure of a composite material.

The function of the process or storage management system 20 is to obtain selected sensor data such as temperature from the composite material (curable part) in the process or storage environment 10 during its operation and to provide settings such as temperature to the remote test device 30 to measure a material sample in a condition known to affect a material state property important to processing and cure. Not all of the environmental conditions of the process or storage environment 10 are reproduced in the remote test device 30. The process or storage management system 20 can also receive sample data from the remote test device 30 for display and (optionally) control of the process or storage environment 10. The process or storage management system 20 may also (optionally) recommend control actions to be taken by an operator by displaying them for example on a monitor, sounding alarms or other means known to those of ordinary skill in the art.

As also illustrated in FIG. 3, the measured data is NOT used in a closed loop fashion with the process control but rather is transferred to the Process or Storage Management System 20. Data is evaluated within the Process or Storage Management System 20 and set points to the production hardware, sometimes referred to as the Process or Storage Environment 10, are determined based on both heat transfer and cure state data.

Various embodiments may have one or more process-monitoring sensors such as thermocouples and pressure gauges placed substantially adjacent to the primary material part to accurately measure or estimate the processing conditions in the process or storage environment 10. Multiple instances of the remote test devices 30 may be used and are often desirable. Thus the process or data storage management system may simultaneously send a single type of sensor data such as temperature from the process or storage environment 10 to a DSC, a rheometer, a Raman Spectrometer and/or thermal expansion measurement device.

Material state sensors may also be present in-situ in the composite material part in the process or storage environment 10. Contrary to the prior art, signals from these in-situ sensors generally will not be used for direct feedback or control but will be sent to the process or storage management system 20 for incorporation into the overall process or storage management strategy. Thus, for example, dielectric data may be monitored to determine when a specific radar transmissivity is achieved as the material cures or ultrasonic data may be used to determine void consolidation. These may be used for quality assurance or to take corrective actions as needed.

Optionally, the process or storage management system 20 will provide correction factors for the in-situ sensors readings using sample data received from the remote test device 30. An example is the conversion of temperature data from the in situ sensors that are at different locations than the temperature sensor used to drive the remote test device 30.

Another example is the use of multiple in-situ sensor environmental measures of conditions such as pressure or vacuum, each of which has at least one sensor that will be used to determine the test conditions in the remote test device 30. In the case of multiple instances of the remote test device 30, each environmental or in-situ sensor may be directed to a different test device 30 appropriate to the property being measured. For example, temperature may be sent to the DSC while pressure readings may be sent to a flow/infusion measurement device.

Various elements that may make up the inventive system contemplated herein include the following.

Environmental Sensors: Sensors that measure the environment substantially adjacent to the composite material part being processed or stored and are positioned such that a reasonable estimate can be made of those environmental conditions that directly affect the material or material state of the composite material part being processed or stored. Examples include sensors for measuring temperature, pressure, and relative humidity. Other examples include measurement of immersion liquids or gases surrounding the material. These measurements are not intended for the purpose of duplicating the total environment but to selectively measure analytically the properties considered critical to performance.

Material State or Material Property Sensors: Sensors that measure the primary composite material part in the process or storage environment or that are designed to provide an estimate of the material state. Typical examples include dielectric or ultrasonic devices that assess intrinsic material properties rather than the environment.

Storage Environment: A location or piece of equipment designed principally to store material or composite materials for future use such as a freezer, cool room, or ambient storage area. In general the function of the storage environment is to minimize or control aging of the material or composite material prior to processing.

Process Environment: The process environment is principally intended to achieve a managed change in the primary composite material part and includes for example equipment such as ovens, autoclaves, presses, integrally heated tools, resin transfer molding equipment, and ambient temperature cure devices.

Process Management System: The process management system reads at least one sensor data point from the processing equipment or storage area (the process or storage environment 10). These data are then used to verify compliance with the desired environmental state or to notify if a manual or automatic adjustment to the environment is required.

In one embodiment, the process or storage management system 20 preferably comprises elements for reading data, processing data, and sending data to and from the remote test devices 30. Preferably, the process or storage management system 20 can provide control signals to the process or storage environment 10. Examples of components of the process or storage management system 20 include but are not limited to computers, data acquisition systems, programmable logic controllers, handheld PCs, or any similar device with the appropriate software.

Analytical Devices or Equipment: The analytical equipment or device(s) contemplated for use herein is any one or more instruments designed to specifically determine a material property. Examples include, but are not limited to, rheometers, calorimeters, differential scanning calorimeters (DSC), thermo-gravimetric analyzers, and dynamic mechanical analyzers. In one embodiment, the term analytical equipment or analytic device also refers to any equipment or device designed specifically for the purpose of material analysis rather than production or duplication of process cycle or conditions.

As described above, the system described herein is designed to analyze, manufacture and cure composite material parts, and samples thereof, which are constructed of bonded structures, sealants, and laminated composites, for example.

Bonding, sealing and laminating materials (matrix) can be of any composition generally known in the art. Common examples include epoxy resins, polyester resins, and polyimides. Less common matrixes include metals, glasses and other inorganic materials. All these materials share common features in that they must flow to wet a solid surface and harden to stiffness appropriate to their application.

The matrix may be a liquid resin that is subsequently hardened by a chemical reaction “curing” or removal of a solvent used to reduce viscosity “drying” or by heating and then cooling “thermoforming”. These structures are typically constructed from fibers that are immersed in a matrix (binder) that flows readily during the forming of the structure, allowing the fibers to be formed into the desired shape or form.

The application of the matrix may occur before the fibers are placed in location “prepreg” (an industry abbreviation of “pre-impregnation”) or after the fiber or other reinforcement is in place. The infusion of the matrix after the fibers can also be done after the fibers have been placed by interspersing layers of resin and fibers, by injecting resins under high pressures, by evacuating air from the fibers and allowing the binder to infuse through capillary action and atmospheric pressure. Structures may also be prepared by simultaneously spraying or applying fiber and resin allowing capillary action to cause the resin infusion. There are various other combinations of the above mentioned. These methods are well known by those of ordinary skill in the art.

The selection of the process and the application of the structure or component can vary widely. However, in every case the infusion of the matrix, the management of entrained gases, the hardening of the matrix and the ultimate performance of the structure are related to the viscoelastic (flow and stiffness) properties of the matrix.

The ratio of reinforcement to resin content depends on the application. Maximum loading for a fiber reinforced laminate will typically be less than 70% by volume of fiber due to the occlusion of the fibers. There is no technical limit to the minimum reinforcement levels, however high fiber loading is generally preferred over low fiber loadings.

### Example 1

FIG. 3 generally identifies the Process or Storage Environment 10, the Process or Storage Management System 20, and the Remote Test Device 30 used in this example. Uncured prepreg (carbon fiber fabric impregnated with an epoxy resin) is placed in an autoclave connected to an autoclave data acquisition system. The autoclave is then set in an idle condition waiting for instructions from the process management system 20.

A separate test sample of the same lot of material used to make the composite material part is placed in an encapsulated sample rheometer test cell 30 compliant with the ASTM D7750-12 test method. The rheometer is placed in a hold state pending instructions from the process management system 20.

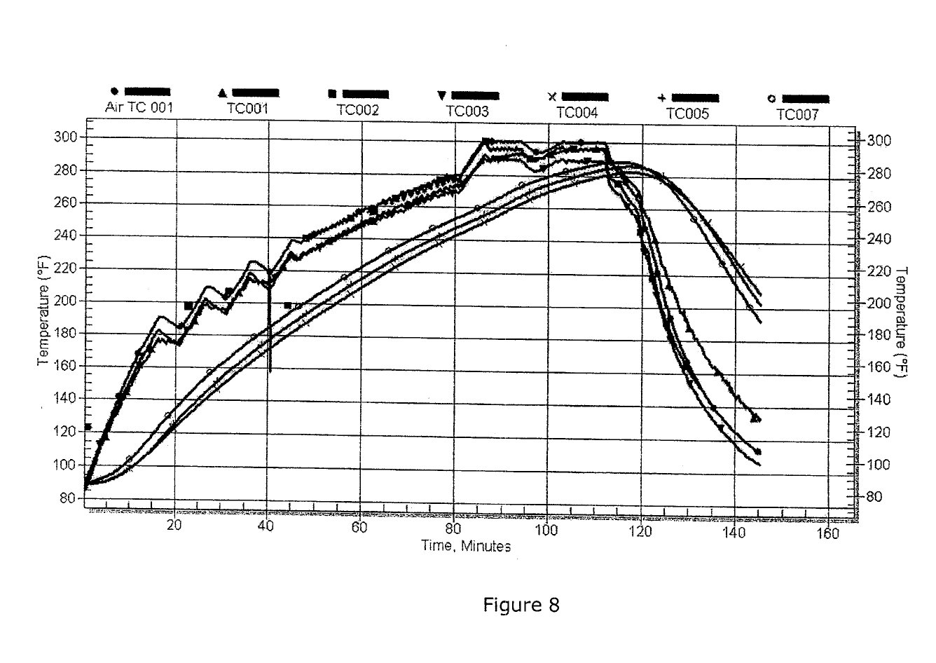

Processing instructions to manage heat transfer and cure state are loaded into the process management system 20, sometimes referred to as the control system 20, and the process is initiated by the operator. The process management system 20 then instructs the autoclave 10 to initiate a heating cycle by sending target values for autoclave air temperature and other parameters to begin the cure process. The process management system 20 then retrieves and stores the actual temperatures of the air, the tooling, and at various part locations (see FIG. 8). Other parameters such as pressure and vacuum over the composite part(s) in the autoclave 10 are also retrieved and stored by the control system 20.

FIG. 8 illustrates a typical temperature distribution for an autoclave cure where air temperature is raised above the part(s) to cause the temperature of the parts to rise thereby creating a temperature distribution caused by a difference in heat transfer rates within the part(s).

Using the temperature data from the parts in the autoclave 10, the process management system 20, sometimes referred to as the “control system 20,” determines a best value of temperature representing the load based on the temperature distribution among the part(s) and the processing instructions loaded prior to beginning the cure. The control system 20 sends this temperature as a set-point to the rheometer 30 with instructions to complete the desired rheology test. Depending on the instructions this value may, for example, be the midpoint between the highest and lowest part(s) temperature, the average or the most critical part.

Using the instructions provided to the control system 20 prior to initiating the cure cycle, the control system 20 then retrieves the results of the rheology test, determines optimum equipment settings for the autoclave 10 and sends the set-points to the autoclave 10. The cycle of measuring the temperature distribution of the part(s), extracting a best value temperature set-point for the rheometer, and using the results from the rheometer and temperature distribution measurements to determine the next autoclave set-points are repeated to manage the progression of the cure and the associated settings of vacuum for volatile removal, pressure for part consolidation, and the end of the process when the viscoelastic state demonstrates final cure is achieved. A final validation of cure is done by ramping the temperature of the sample in the rheometer 30 through its glass transition temperature, at heat rates that cannot be achieved by the autoclave, and up to a temperature above the operating limits of the autoclave. Upon successful validation of the glass transition temperature, the process management system 20 extrapolates the test results to the lagging part temperature to insure all locations in the load are fully cured and when this is achieved, instructs the autoclave 10 to terminate the cure.

A basic assumption of the presently disclosed inventive concept(s) is that the conditions of a test sample in an analytic instrument 30 do not replicate the complete process conditions within the autoclave 10, but rather the analytical instrument 30 optimizes for the accuracy of the sample measurements which are then used to approximately represent the cure status of entire part or loading parts within the autoclave 10.

This constitutes a basic novel and non-obvious aspect of the presently disclosed curing methods. Earlier control methods have always attempted to measure viscosity within an autoclave, ignored the final stages of cure, did not encapsulate the sample to assure containment of the resin, and attempted to cause the processing equipment to fully duplicate the process environment in order to achieve an identical environment via transitivity when measurement was done in a separate autoclave. The present approach is contrary to the conventional wisdom that in situ measurements are the most accurate way to measure the cure state of a part, and teaches against the conventional belief that measurements should be taken in situ or where all conditions within the process environment are duplicated in the remote test device.

The plot in FIG. 4 shows the sample temperature of the rheometer 30 following the temperature as sent by the process management system 20 that was derived from multiple thermocouples on the part. The viscosity and stiffness of the test sample is measured by the rheometer 30 throughout the curing process are plotted as the elastic modulus and loss modulus in units of kPa. During the run, the buildup of the elastic modulus (G′) is observed. As the run progresses, the passage of the glass transition state through the cure temperature is noted by the peak in the loss modulus (G″) followed by the rapid rise in the elastic (storage) modulus (G′) of the test sample. FIG. 4 shows a graph which, in one embodiment, displays the information obtained from the test sample in the rheometer 30. A more complete discussion of cure determination is described in the ASTM test method D7750-12, the content of which is hereby expressly incorporated herein by reference.

This ASTM method was developed following the first filing of the parent of the present application and using the teachings of the parent application. This method was developed under peer review to support the novel teachings of this application and address the need for a new method. The rheological data shown in FIG. 1, FIG. 2 and FIG. 4 through FIG. 7 were developed using the methods of the presently disclosed inventive concept(s). Prior art methods using Dynamic Mechanical Analysis (DMA) such as those of Starita (U.S. Pat. No. 4,095,461) are non-quantitative for composite prepreg materials and fail altogether when the material gels and long before final cure. The presently disclosed novel method of cure determination in the viscoelastic domain was developed to allow analytical tracking of cure state throughout the cure and necessitated the development of the new ASTM test method 7750-12.

The data in FIG. 4 show the initial decrease in viscosity (loss modulus) and spring back (storage modulus) of the test sample throughout the temperature cure cycle. This information can be used to determine when the composite material part in the process or storage environment has met the cure target for consolidation and when the cure cycle can be terminated.

This approach enables quantitative tests with accuracy traceable to NIST and methods supported by internationally recognized standards organizations. Thus the process can be terminated much sooner, saving time, labor and expense and resulting in improved quality of the cured composite material part with greater confidence in the accuracy and reliability of the results. For example, in the present example, the cure of the composite material part in the process or storage environment 10 could have been terminated at approximately 150 minutes into the cycle thereby resulting in a 20% savings in cure time. The information obtained from the remote test device 30 can also be used in the development of improved thermal cycles.

### Example 2

The test sample is prepared and processed as in Example 1 except that rheology data obtained from the remote test device 30 is sent to the process or storage management system 20 which initiates a pressurization cycle in the process or storage environment 10 when the test sample exhibits the viscosity appropriate for pressurization.

In one embodiment, the data provided and displayed in the graphs would be used to optimize the process cycle in the process or storage environment 10 by providing information on the state of the test sample. For example, the pressurization to consolidate the composite material part in the process or storage environment 10 is begun as the loss modulus value of the test sample in the remote test device 30 passes 1000. This value is chosen because the resin begins to harden and thus will not further soften and allow the resin to escape the laminate.

### Example 3

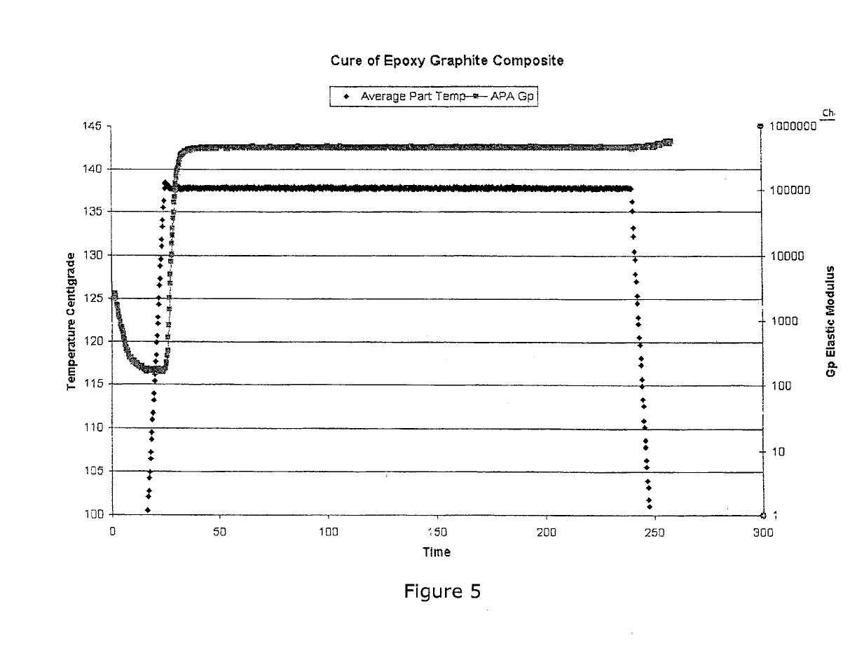

The process is similar to Example 1 or 2 except the composite material part in the process or storage environment 10 is cured at about 137° C. (see FIG. 5). The elastic modulus of the test sample in the remote test device 30 rises to a steady value after approximately fifty minutes. The standard cure cycle requires the composite material part to remain in the oven (the process or storage environment 10) for an additional three hours or almost a factor of six beyond reaching the glass transition state of the cure temperature (e.g., wherein there is no change in the elastic modulus at that temperature for the duration of the cure cycle). Although other factors may require additional cure time, it is evident that it is possible to determine when the modulus has been achieved for the selected cure temperature and thus when the cure cycle can be terminated. In this case, the cure cycle could have been terminated about three hours earlier than the standard cure instructions dictate, resulting in a significant savings of time, money and labor.

### Example 4

The material part preparation and pressurization is the same as in Example 2 except that the material is a thermoplastic material part and the pressure will be applied after the thermoplastic exhibits the viscosity appropriate for pressurization.

### Example 5

The process is the same as Example 2 except that an independent thermal cycle is initiated on the rheometer at the end of the cure cycle to estimate the viscoelastic response and glass transition temperature of the cured composite material part.

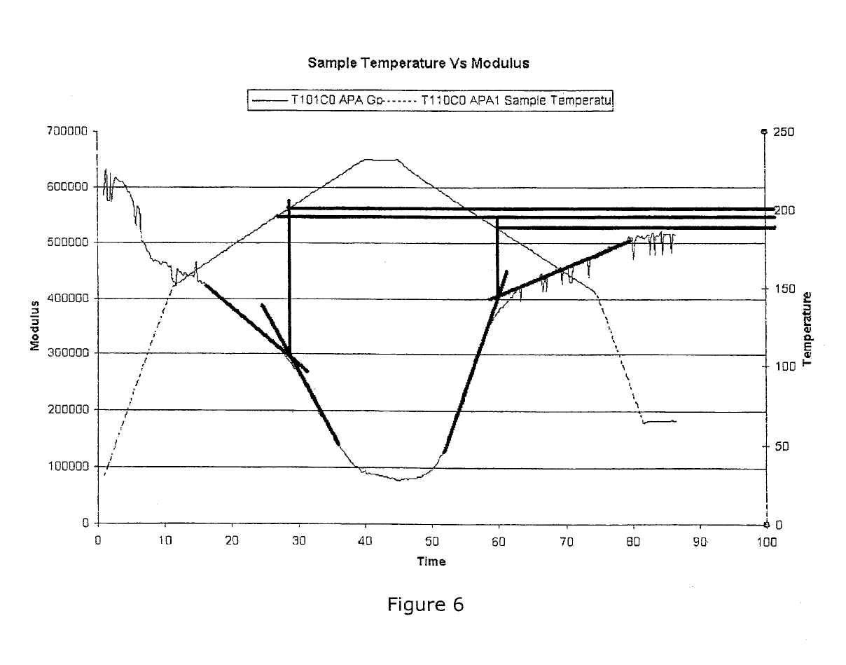

The following two figures illustrate the change in the composite material part stiffness as a function of temperature. These measurements are made by instructing the instrument to initiate a temperature scan after completing cure on the sample of laminate from the previous example. As shown in FIG. 6, a glass transition temperature range of approximately 180° C. to 200° C. is observed when measuring the change of the elastic modulus (G′) in the material.

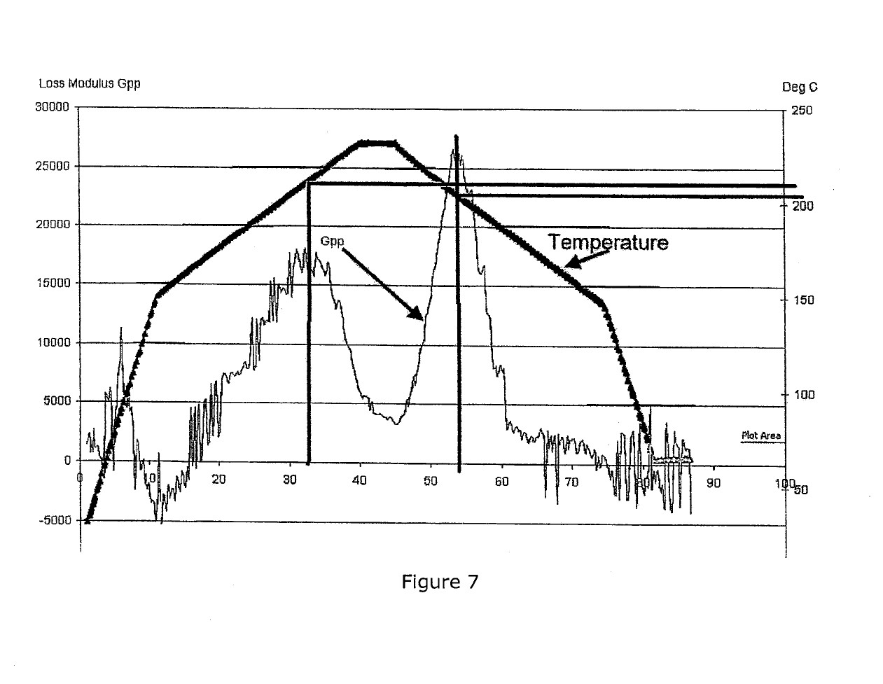

The loss modulus (G″) is also measured (see FIG. 7) in the same sample concurrently with the elastic modulus (G′) measurement. The glass transition region as measured by peak in loss modulus is in the range of 200° C. to 220° C. A detailed interpretation of the significance of the graph is not believed necessary. However, it is clear from these graphs to a person of ordinary skill in the art that substantial information regarding the cure state of these materials can be gained at very little cost using the teachings herein.

### Example 6

The process is the same as Example 2 except that the analytical device (remote test device 30) is a differential scanning calorimeter (DSC). In this case the data is a measure of the heat evolution and uptake of the same and provides an indication of chemical reactions and phase change, e.g. melting or glass transitions. This embodiment would be useful, for example, if the goal was to determine the rate of the chemical reaction in the composite material part rather than changes in the viscoelastic state. This is useful for developing and validating cure models to evaluate and control the cure of the material.

### Example 7

The process is the same as Example 2 except that the analytical device (remote test device 30) is a thermo-gravimetric analyzer. This instrument is used to determine when weight change such as a loss of weight of the composite material part is occurring during a cure. In Example 2 this weight loss would primarily be absorbed water that would change the cure kinetics and that could act as a blowing agent to cause voids in the laminate. For other resin systems such as polyimides, volatiles are given off as reaction products during of the cure and must be removed prior to consolidation of the laminate.

### Example 8

The process is the same as Examples 1 or 2 except that a plurality of thermocouples are used and a predefined model is used to estimate viscoelastic state based on temperatures at the various thermocouple locations (FIG. 8). Using the methods described in the previous examples to obtain data during regular production cycles, models of the expected viscoelastic and other parameters can be developed. Previous approaches using cure models have limited value because of variations in the resin from batch to batch. By obtaining measured material state values such as the viscoelastic properties of Example 1, the model can be extended to other temperature histories within the batch. This greatly improves the accuracy and therefore the value of the cure model.

### Example 9

The process is the same as Example 8 except that a single thermocouple is used and temperatures in other zones of the part are estimated using heat transfer and heat of reaction models.

### Example 10

The process is the same as Example 8 except that a model is developed in real time based on viscosity values from the rheometer.

### Example 11

The process is the same as Example 1 or 2 except that an in-situ sensor that measures pressure in the process or storage environment 10 is added.

### Example 12

The process is the same as Example 8 or 9 except that in-situ sensors such as conductivity, ultrasonic, light scattering or other sensors that are also compared or corrected with the data from the rheometer.

### Example 13

The process is the same as Example 12 except that the in-situ sensor is a fiber optic Raman or other device intended to measure chemical reaction rather than viscoelastic properties and the instrument is a Raman spectrometer or DSC or other device to analyze for the chemical reaction.

As explained above, U.S. Published Patent Application No. 2001/0006264 A1 of Wit et al., shows a system in which a curable part is cured in a process environment (e.g., a production autoclave) and the cure cycle of the process environment is directed by in-situ dielectric sensor measurements of a test sample which is being cured within a smaller test autoclave separate from the process environment, and wherein the in-situ dielectric sensors are within the smaller test autoclave.

The present inventive concepts differ from Wit et al., in several regards. First, the analytic device of the present embodiments is not a second (test) autoclave, and thus differs from Wit et al., in that Wit et al., requires use of a second (test) autoclave. Second, the analytic device of the present embodiments is not a system placed within a second (test) autoclave, and thus differs from the dielectric sensors (or other sensors) used or contemplated by Wit et al. Further, the analytic device of the present embodiments operates at under ambient conditions typical of a laboratory environment and not under conditions which exist in a process environment such as a production autoclave during a cure process. The sensors used in the test autoclave of Wit et al. are not operated at ambient conditions, but at conditions of temperature and pressure which duplicate those in a production environment.

Therefore, the analytic device used in the present embodiments is not an autoclave, the analytic device used in the present embodiments does not operate within an autoclave (i.e., a second cure apparatus) and the analytic device used in the present embodiments is not subjected to pressure and temperature conditions to which a curable part is subjected within a process environment. Further, a small autoclave as described by Wit lacks the characteristics of the type of analytical device defined in this specification. Contrary to the function of Wits test autoclave to create a new standard of measurement with each lot of material referenced to a prior test of the same material under the same condition, a function of the analytical device in the presently disclosed inventive concept(s) is to accurately tie material properties to existing standards traceable to NIST without prior knowledge of the material or its cure state.

In the presently disclosed inventive concepts, there is no requirement for identity (duplication) of process or product to maintain the integrity of the data. For example, as noted above, the analytical device of the presently disclosed inventive concept(s) does not require the pressure and temperature duplications essential to the operation of the Wit et al. device in order to duplicate the process environment conditions to which the curable part is subjected within the process environment.

These features distinguish the presently disclosed inventive concept(s) from the apparatus and process described in the Wit et al. reference, since Wit et al. use a secondary (test) autoclave to take test measurements. Such test measurements (of Wit et al.) of the test sample are taken within the test autoclave, and the measuring devices (dielectric sensors) used by Wit et al. to obtain the test measurements from the test sample operate within the test autoclave and thus are subjected to similar pressure and temperature conditions (within the test autoclave) to which the curable part is subjected within the process environment.

Calibration of the sensors of Wit et al. depend on the conditions of the test autoclave being the same as those in the process environment, while to the contrary, the analytic device of the presently disclosed inventive concept(s) is a device which is specifically designed to operate on the test sample to obtain specific material properties therefrom. The analytic device may be a rheometer, calorimeter, differential scanning calorimeter (DSC), thermo-gravimetric analyzer, dynamic mechanical analyzer, or Raman spectrometer for example. The analytic device operates as an independent component of the system of the presently disclosed inventive concept(s) (not as a part of a secondary autoclave), wherein the analytic device (remote test device 30) is operatively linked to a production process management system and only secondarily to the process environment. The analytic device (remote test device 30) is a separately functioning component of the system. The analytic device of the presently disclosed inventive concept(s) does not operate from within a second cure apparatus such an autoclave.

Further, the analytic devices taught herein as comprising the remote test device 30 (e.g., rheometers, calorimeters, thermogravimetric analyzers, etc.) are designed to be operated in laboratory environments under ambient conditions (e.g., room temperature, at or near atmospheric pressure) and would be destroyed under the high pressure and high temperature conditions to which the curable part is subjected within the process environment (or in a secondary test autoclave).

A fundamental, novel, and non-obvious difference between the analytical device used in the presently disclosed inventive concept(s) and the sensors of the prior art (e.g., Wit et al.) is that the prior art systems rely on “in-situ” sensors to measure parameters, while the presently disclosed inventive concept(s) relies on “ex situ” measurement of parameters i.e., wherein “ex situ” measurements are defined as measurements of parameters in test samples which are not being subjected to the same conditions as those in the process environment.

“In-situ” measurements taken from sensors which are placed within the curable part in the process environment are subjected to the same conditions as the primary curable part (e.g., such as the dielectric sensors of Wit et al).

Since the measurements of the test sample of the presently disclosed inventive concept(s) are taken “ex situ,” this implicitly means that the remote test device 30 is not being subjected to the same conditions, e.g., pressures, that the curable part is being subjected to within the process environment. In Example 2, viscosity measurements taken from the test sample using the rheometer (e.g., the remote test device 30 of one embodiment) are used by the cure management systems (process or storage management system 20) to control pressurization of the curable part (in the process environment 10). In particular, it is indicated that when the loss modulus of the test sample in the test device 30 passes 1000, the pressurization cycle is initiated in the process environment 10 to subject the curable part to pressure to prevent resin from escaping the laminate of the curable part. There is no equivalent request by the cure management system 20 for “pressurization” of the test sample in the rheometer or of the rheometer (test device) itself since (1) the rheometer of the example does not have means for controlling pressure of the test sample in a manner similar to that of the process environment 10 and (2) the rheometer is not contained within a pressurizable system (e.g., an autoclave) because, as noted above, the rheometer itself is the remote test device 30, which is shown as operating herein as an independent entity. This example demonstrates that the remote test device 30 of the presently disclosed inventive concept(s) is not subjected to the same pressurization conditions as the primary curable part within the process environment.

In fact, it is well known in the art that rheometers, calorimeters, thermo-gravimetric analyzers, Raman analyzers and similar analytic devices used to make ex-situ measurements of material properties would themselves be destroyed or functionally impaired if subjected to the temperature and pressure conditions present within the process environments used to cure curable parts contemplated herein. As noted elsewhere herein, the analytic devices of the presently disclosed inventive concept(s) clearly do not function as a replacement of the in-situ dielectric sensors (or other types of sensors) within a test autoclave.

As noted above, Wit et al. disclose a system in which a curable part is cured in a process environment (e.g., a production autoclave) and the cure cycle of the process environment is directed by measurements of a test sample made using dielectric sensors wherein the test sample is being cured within a smaller test autoclave creating the same conditions as in the process environment and wherein the dielectric sensors are within the smaller test autoclave.

As noted elsewhere, in the method of the presently disclosed inventive concept(s), the analytic device is not an autoclave, the analytic device does not operate within a second cure apparatus (e.g., an autoclave), and the analytic device is not subjected to the same temperature and pressure conditions to which the curable part is subjected within the process environment.

These features distinguish the presently disclosed inventive concept(s) from the apparatus and process described in the Wit et al. reference since in the Wit et al. reference, Wit et al. use a secondary test autoclave to take test measurements, Wit et al's. test measurements of the test sample are taken within the test autoclave, and the measuring devices (e.g., dielectric sensors) used by Wit et al. to obtain the test measurements from the test sample are subjected substantially to the same temperature and pressure conditions (within the test autoclave) to which the curable part is subjected within the environment.

The presently disclosed inventive concept(s) relies on “ex situ” measurements of a test sample of the curable part, that is, the measurements of the test sample are taken from devices which are not subjected to the same conditions, e.g., pressures and temperatures, that the curable part is being subjected to within the process environment.

In one embodiment the present method uses an analytical device to directly measure a mechanically-derived viscoelastic property, including loss modulus and storage modulus, in the test sample, and uses the direct measurements of mechanically-derived viscoelastic properties including loss modulus and storage modulus to control curing of the curable sample during the curing of the curable part.

As stated above, Wit et al., teach a method of using dielectric sensors to take measurements of electrical conductivity in a test sample. However, ionic viscosity is not a direct mechanically-derived measurement of the viscoelastic properties of a material such as loss modulus and storage modulus. Ionic viscosity measures the potential for flow of ions through a material, but is not a direct measurement of the mechanical flow (loss modulus) of resin within a curable part. Moreover, ionic viscosity is not representative of the storage modulus (elastic) property of the curable part.

The viscosity of a polymer has a purely mechanical definition: viscosity is the internal friction of a fluid, caused by molecular attraction, which makes it resist a tendency to flow. One direct measure of this “internal fluid friction” is to consider the force required to shear a thin layer of fluid. Shearing occurs when the fluid is poured, spread, or mixed, for example. The corresponding mathematical definition of viscosity is:

$$viscosity = η = \frac{shear stress}{shear rate}$$

The fundamental unit of viscosity measurement is the poise which has units of (force/length²)*time. Thus, the viscosity is characterized by a mechanical test of the fluid resistance to flow. One common mechanical test for polymer viscosity entails shearing a fluid layer between two parallel plates. Other techniques involve fluid shearing between a cone and plate, or a cup and spindle. These mechanical approaches to measuring viscosity are classified as rheological measurements.

Ionic viscosity is a term which has been used by some to assert an association between conductivity and viscosity. However, there is no indication that “ionic viscosity” (i.e., the electrical measurement of the material) has a causal relationship with the real viscosity of the material during a curing process. In fact, the relationship between the magnitude of the electrical measurement and the viscosity of the material could be and is affected by many factors that might increase or decrease the electrical conductivity of the material such as fillers, residual salts and handling of the materials. There is thus a distinct difference and often poor correlation between the electrical measurement of ion mobility and a mechanical measure of viscosity. The mechanical measurement of viscosity (e.g., by rheometer) is a universally accepted measure of the physical shearing behavior of a fluid, while the “ionic viscosity,” is not.

Thus, the dielectric measurements taken by Wit et al., during the cure process are not true measurements of viscosity of the test sample, therefore Wit et al., do not teach measuring viscoelastic properties of a test sample and then relating them to a separate part being concurrently exposed to a cure cycle.

As shown in FIG. 2 of the present application, which indicates both the elastic (storage modulus) and the viscous (loss modulus), it can be readily seen that the loss modulus correlates in an inexact manner to the ionic conductivity (and moreover, ionic conductivity only monitors the early stages of cure, while the resin is liquid). The storage modulus, which monitors cure state after the resin gels continues to change, is critical to assessing the strength of the structure; ionic conductivity fails to provide information in this critical region of the curing process.

It would be impossible to directly measure mechanically-derived viscoelastic properties of the curable test sample (such as storage and loss modulus) by using the methods of Wit et al., which rely on taking measurements of the test sample within an autoclave, due to the untenable physical conditions (high pressures and temperatures) to which the analytic device would be subjected if located within an autoclave.

Furthermore, use of direct feedback of electric signals to control a process environment as used in Wit et al., has serious problems. Feedback signals from in-situ sensors are highly variable in amplitude and often for reasons other than a change in cure state. As noted above, these signals fail after gelation and well before the final desired cure state of the material is achieved. In the methods of the presently disclosed inventive concept(s), the data are sent to a process management system for incorporation into an overall storage and management strategy. This is an important difference between systems and methods such as Wit et al., and the presently disclosed inventive concept(s).

As noted above, the dielectric measurements taken by Wit et al., (referred to by Wit et al., as “ionic viscosity”) do not accurately measure viscosity or flow of the composite material. It is important to note that 100% of a dielectric scale typically occurs before the composite structure attains the required mechanical strength and could ultimately result in structural failure causing death and loss of property if used to determine the end of the cure cycle of the structure.

In an article by S. D. Senturia and N. F. Sheppard, Jr. (“Dieletric Analysis of Thermoset Cure”. Advances in Polymer Science 80. Springer-Verlag), the use of dielectric (ionic conductivity) measurements is promoted for monitoring cure state but this tends to overlook the considerable difficulty in obtaining meaningful measurements. In Senturia et al., moreover, ionic conductivity is not equated to viscosity although it is stated that ionic conductivity is “nominally” proportional to viscosity in systems Senturia et al., studied.

In particular, Senturia et al., while indicating that the relation between the mobility of the ions and the properties of the resin can be qualitatively examined with the aid of Stoke's law for the drift of a spherical object in a viscous medium they go on to state that: “ . . . it must be emphasized, however, that this Stoke's law approach is an oversimplification which fails completely as a curing resin approaches gelation.” (Emphasis added).

In other words, Senturia et al., admit that in real situations at the stage where a composite part gels and sets, the entire theory of the usefulness of ionic conductivity of the composite part fails. Therefore, if the correlation between ionic conductivity and viscosity fails at any point during the curing process, ionic conductivity cannot be asserted as an accurate measurement of viscosity.

In view of the above it is clear that the method proposed by Wit et al., not only does not measure a viscoelastic state, it could result, in fact, in the dangerous conclusion that the part was cured when it was not. If this part were put in service in a real life situation, it could result in a catastrophic failure of the structure—be it a golf shaft, bridge or an aircraft.

Thus, in accordance with the presently disclosed inventive concept(s), there has been provided methods of curing and methods of estimating a cure state of a curable part that fully satisfy the advantages set forth herein above. Although the presently disclosed inventive concept(s) has been described in conjunction with the specific language set forth herein above, it is evident that many alternatives, modifications, and variations will be apparent to those skilled in the art. Accordingly, it is intended to embrace all such alternatives, modifications, and variations that fall within the spirit and broad scope of the presently disclosed inventive concept(s). Changes may be made in the construction and the operation of the various components, elements, and assemblies described herein, as well as in the steps or the sequence of steps of the methods described herein, without departing from the spirit and scope of the presently disclosed inventive concept(s).

What is claimed is:

1. A method of curing a composite material part, comprising:
disposing a curable part(s) within a process environment, the curable part comprising a resin and fiber composite material;
disposing a test sample constructed of a same resin and fiber composite material as that used to construct the curable part(s), in analytical equipment comprising a rheometer which is separate from the process environment;
obtaining multiple temperature measurements of air within the process environment while the curable part is being subjected to selected curing conditions of a cure cycle;
obtaining multiple temperature measurements substantially adjacent the curable part(s) at multiple locations of the curable part(s) within the process environment while the curable part is being subjected to the selected curing conditions, and determining a representative part temperature based on the multiple temperature measurements substantially adjacent the curable part(s);
adjusting a setting of the analytical equipment so as to control the temperature of the test sample to equal the determined representative part temperature and obtaining real time measurements of the test sample including viscoelastic properties of the test sample at the determined representative part temperature and under conditions within operating specifications of the instrument;
controlling an air temperature within the process environment using a process management system having a computer program with instructions for computing an air temperature set point and adjusting that set point based in part on the real time viscoelastic property measurements of the test sample; and
estimating a cure state of the curable part(s) based on the real time measurements of the test sample and the multiple temperature measurements substantially adjacent the curable part(s) at multiple locations of the curable part(s).

2. The method of claim 1, wherein the analytical equipment further comprises a calorimeter.

3. The method of claim 2, further comprising:
obtaining real time measurements of the heat generation and absorption of the test sample; and
estimating heat generation and absorption of the curable part based on the heat generation and absorption measurements of the test sample.

4. The method of claim 1, wherein the analytical equipment further comprises a thermo-gravimetric analyzer.

5. The method of claim 4, further comprising:
obtaining real time measurements of the weight change of the test sample at the temperature approximating the curable part temperature; and
estimating weight change of the curable part based on the weight change measurements of the test sample.

6. The method of claim 1, wherein the analytical equipment further comprises a Raman spectrometer.

7. The method of claim 6, further comprising:
obtaining real time measurements of the absorption or emission spectra of the test sample at the measured temperature substantially adjacent to the curable part; and
estimating a chemical composition or chemical change in the curable part during the curing of the curable part based on the absorption or emission spectra measurements of the test sample.

8. The method of claim 1, further comprising the steps of terminating the curing conditions of the cure cycle and obtaining additional rheological measurements of the test sample to estimate the glass transition temperature of the resin and fiber composite part once curing conditions are terminated.

9. The method of claim 1, further comprising the steps of terminating the curing conditions of the cure cycle when the viscoelastic property measurements of the test sample over time show a loss modulus peak followed by a decline of the loss modulus to levels near zero where readings become erratic.

10. The method of claim 1, further comprising:
estimating multiple cure states of the curable part(s) based on the real time measurements of the test sample and the multiple temperature measurements substantially adjacent the curable part(s) at multiple locations of the curable part(s).

11. The method of claim 10, further comprising:
terminating the curing conditions when the multiple cure state estimates of the curable part(s) and the multiple temperature measurements substantially adjacent the curable part(s) indicate the curing process is complete.

12. The method of claim 10, wherein the analytical equipment further comprises a calorimeter.

13. The method of claim 12, further comprising:
obtaining real time measurements of the heat generation and absorption of the test sample; and
estimating heat generation and absorption of the curable part based on the heat generation and absorption measurements of the test sample.

14. The method of claim 10 wherein the analytical equipment further comprises a thermo-gravimetric analyzer.

15. The method of claim 14 further comprising:
obtaining real time measurements of the weight change of the test sample at the temperature approximating the curable part temperature; and
estimating weight change of the curable part based on the weight change measurements of the test sample.

16. The method of claim 10 wherein the analytical equipment further comprises a Raman spectrometer.

17. The method of claim 16 further comprising:
obtaining real time measurements of the absorption or emission spectra of the test sample at the measured temperature substantially adjacent to the curable part; and
estimating a chemical composition or chemical change in the curable part during the curing of the curable part based on the absorption or emission spectra measurements of the test sample.

18. The method of claim 10, further comprising the steps of terminating the curing conditions and obtaining additional rheological measurements of the test sample to estimate the glass transition temperature of the resin and fiber composite part once curing conditions are terminated.

19. The method claim 10, further comprising the step of adjusting at least one process environment condition prior to the multiple cure state estimates indicating the curing process is complete.

20. The method of claim 19, wherein the process environment condition is temperature and the temperature is adjusted to maintain a constant viscosity as the composite material cures to maximize infusion of the resin among the fibers.

21. The method of claim 19, wherein the curable part comprises a laminate and wherein the at least one process environment condition is adjusted to allow the curable part viscosity to increase and restrict flow as pressure is applied to a surface of the laminate causing pressure to build within the resin and close voided areas.

22. The method of claim 19, wherein a selected curable part temperature is held constant until test sample measurements show that loss modulus has peaked and then diminished to a level indicating a fully elastic state such that residual stress in the curable part is minimized at the selected temperature.

23. The method of claim 19, wherein the step of adjusting at least one process environment condition causes the resin viscosity to increase such that the resin is solid at room temperature but re-melts when placed within another part for more complex structures.

24. The method of claim 19, wherein the process environment is an autoclave and wherein the autoclave curing conditions are terminated before the cure cycle is complete and wherein the real time measurements of the test sample indicate the glass transition temperature is high enough to allow the curable part to be removed from the autoclave and the cure cycle completed in a less expensive oven.
